(19) United States
(12) Patent Application Publication
(10) Pub. No.: US 2026/0125113 A1
(43) Pub. Date: May 7, 2026

(54) SIDE SILL STRUCTURE FOR ELECTRIC VEHICLE

(71) Applicants: Hyundai Motor Company, Seoul (KR); Kia Corporation, Seoul (KR)

(72) Inventors: Seungho NOH, Hwaseong-si (KR); Seung Min Kang, Hwaseong-si (KR); Sumin Oh, Hwaseong-si (KR)

(21) Appl. No.: 19/314,741

(22) Filed: Aug. 29, 2025

(30) Foreign Application Priority Data
Nov. 4, 2024 (KR) 10-2024-0154059

(51) Int. Cl. B62D 25/02; B60K 1/04; B62D 25/20; H01M 50/224; H01M 50/242; H01M 50/249

(52) U.S. Cl. CPC B62D 25/025; B60K 1/04; B62D 25/2036; H01M 50/224; H01M 50/242; H01M 50/249; B60K 2001/0438; H01M 2220/20

(57) ABSTRACT

A side sill structure for a vehicle can include a sill inner member connected to each side of a floor structure at a vehicle width direction and arranged along a front-rear direction of a vehicle body, an upper reinforcing member connected to an outer surface of the sill inner member and arranged along the front-rear direction of the vehicle body, a lower reinforcing member connected to a lower surface of the upper reinforcing member and the outer surface of the sill inner member, and arranged along the front-rear direction of the vehicle body, and a sill outer member connected to the outer surface of the sill inner member and the upper reinforcing member and positioned along the front-rear direction of the vehicle body.

### CROSS-REFERENCE TO RELATED APPLICATIONS

This application claims priority to and the benefit of Korean Patent Application No. 10-2024-0154059 filed with the Korean Intellectual Property Office on Nov. 4, 2024, the entire contents of which are incorporated herein by reference.

### TECHNICAL FIELD

The present invention relates to a side sill structure for an electric vehicle.

### BACKGROUND

Recently, due to environmental regulations and fuel efficiency regulations, the use of electric vehicles driven by electric power sources is increasing.

Electric vehicles are equipped with a battery assembly that supplies electricity to the electric drivetrain. The battery assembly, in one example, is mounted on the lower portion of the floor structure in the vehicle body of an electric vehicle.

For electric vehicles, the main factor affecting the range (or travel distance) is the battery volume ratio of the battery assembly. The more battery cells that can be installed in the limited space of the battery assembly, the greater the range of the electric vehicle.

Battery volume ratio may be deteriorated due to components with overlapping mechanical strength between the vehicle body and the battery assembly (e.g., side components of the battery assembly that are connected to the vehicle body) and battery mount components of the battery assembly.

On the other hand, as the demand for electric vehicles has increased recently, the development of a vehicle body that can satisfy collision performance is required. In particular, there is a need for the development of a vehicle body that can protect the battery assembly in the event of a side collision of an electric vehicle.

The information contained in this Background section is intended to promote understanding of the background of the present disclosure and may include matters that are not conventional art already publicly known, available, or in use.

### SUMMARY

The present disclosure relates to a vehicle body structure for an electric vehicle, and more particularly, the present disclosure relates to a side sill structure for an electric vehicle with improved lateral collision performance.

An embodiment of the present disclosure can provide a side sill structure for an electric vehicle that can minimize side sill rotation and reduce collision energy transmitted to a battery assembly in a side collision of the electric vehicle.

A side sill structure for an electric vehicle according to an embodiment of the present disclosure may include a sill inner member connected to each side of a floor structure along a vehicle width direction and arranged along a front-rear direction of a vehicle body, an upper reinforcing member connected to an outer surface of the sill inner member and arranged along the front-rear direction of the vehicle body, a lower reinforcing member connected to a lower surface of the upper reinforcing member and the outer surface of the sill inner member, and arranged along the front-rear direction of the vehicle body, and a sill outer member connected to the outer surface of the sill inner member and the upper reinforcing member and positioned along the front-rear direction of the vehicle body.

Floor panels and cross members provided in the floor structure may be connected on both sides along the vehicle width direction to an inner surface of the sill inner member.

The cross members and the upper reinforcing member may be placed on a first imaginary line along the vehicle width direction.

The sill inner member may be connected to side frames on both sides of a battery assembly mounted on the lower part of the floor structure.

A side surface of the upper reinforcing member connected to the outer surface of the sill inner member and a side surface of the side frame may be arranged on a second imaginary line along the vertical direction.

A section from the side surface of the upper reinforcing member and the side surface of the side frame to the sill outer member may be set as a transformation section.

The upper reinforcing member may include an aluminum extrusion member.

The aluminum extrusion member may include a plurality of closed sections separated by at least one barrier rib.

The lower reinforcing member may include a plurality of cell assemblies connected sequentially along the front-rear direction of the vehicle body.

The lower reinforcing member may be formed in a honeycomb shape along the front-rear direction of the vehicle body by the cell assemblies.

The cell assemblies may include an upper cell body of steel material connected to the lower face of the upper reinforcing member, and a lower cell body of steel material connected to the lower part of the upper cell body and connected to the outer surface of the sill inner member.

The upper cell body may be equipped with an “M” shaped cross-section.

The lower cell body may be equipped with a “U” shaped cross-section.

The upper cell body may include an upper forming part that is formed concavely from the top to the bottom, an upper connecting part which extends forward and backward from the upper forming part and is connected to the lower surface of the upper reinforcing member, and upper rib portions each extending downward from the upper connecting part.

The lower cell body may include a lower connecting part formed along the front-rear direction of the vehicle body and connected to the outer surface of the sill inner member, and lower rib portions extending upward from each side of the lower connecting part.

The upper rib portions and the lower rib portions of each of the cell assemblies may be connected by welding.

The upper rib portions and the lower rib portions of the cell assemblies, which may be adjacent to each other along the front-rear direction of the vehicle body, can be connected by welding.

Weld nuts that penetrate the sill inner member and the lower cell body in the vertical direction may be connected to the sill inner member.

With a side sill structure for an electric vehicle according to an embodiment of the present disclosure, side sill rotation due to side collision energy can be minimized, so that the battery assembly can be safely protected and the battery integration and volume ratio of the battery assembly can be improved.

Advantages that can be obtained or expected due to an embodiment are directly or implicitly disclosed in the detailed description. That is, various advantages predicted according to an embodiment of the present disclosure will be disclosed in the detailed description that follows.

### BRIEF DESCRIPTION OF THE DRAWINGS

Embodiments of this specification may be better understood by reference to the following description taken in conjunction with accompanying drawings in which similar reference symbols can designate identical or functionally similar elements.

FIG. 1 is a top plan view illustrating a side sill structure for an electric vehicle according to an embodiment of the present disclosure.

FIG. 2 is a partial exploded perspective view illustrating a side sill structure for an electric vehicle according to an embodiment of the present disclosure.

FIG. 3 is an exploded perspective view illustrating a side sill structure for an electric vehicle according to an embodiment of the present disclosure.

FIG. 4 is a perspective view illustrating a side sill structure for an electric vehicle according to an embodiment of the present disclosure.

FIG. 5 is a cross-sectional view along line B-B of FIG. 1.

FIG. 6 is a combined perspective view illustrating a lower reinforcing member applied to a side sill structure for an electric vehicle according to an embodiment of the present disclosure.

FIG. 7 is an exploded perspective view illustrating a cell assembly of a lower reinforcing member applied to a side sill structure for an electric vehicle according to an embodiment of the present disclosure.

FIG. 8 is a cross-sectional view illustrating a battery assembly mounting structure of a side sill structure for an electric vehicle according to an embodiment of the present disclosure.

FIG. 9 is a drawing for explaining an operation of a side sill structure for an electric vehicle according to an embodiment of the present disclosure.

FIG. 10 is a drawing illustrating an example for comparison with a side sill structure for an electric vehicle according to an embodiment of the present disclosure.

The drawings referenced above are not necessarily to scale, and can be understood as presenting rather simplified representations of various features illustrating some basic principles of an embodiment of the present disclosure. For example, certain design features of an embodiment of the present disclosure, including particular dimensions, direction, position, and shape, can be determined in part by a particular intended application and usage environment.

### DETAILED DESCRIPTION OF ILLUSTRATIVE EMBODIMENTS

Hereinafter, with reference to the attached drawings, example embodiments of the present invention will be described in detail so that a person having ordinary skill in the art to which the present disclosure pertains can easily practice an embodiment of the present disclosure. As those skilled in the art would realize, the described embodiments may be modified in various different ways, all without departing from the spirit or scopes of the present disclosure.

The terminology used herein is for the purpose of describing particular example embodiments only and is not intended to necessarily limit the present disclosure. As used herein, singular forms can be intended to include plural forms as well, unless the context clearly indicates otherwise.

It can be understood that the terms “comprise” and/or “include” as used herein indicate the presence of stated features, integers, steps, operations, elements, and/or components, but do not preclude the presence or addition of one or more other features, integers, steps, operations, components, and/or groups thereof. As used herein, the term “and/or” includes any and all combinations of one or more of the associated listed items. In this specification, the term “connected” can indicate a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle,” “vehicular,” “automotive” or other similar terms as used herein can generally refer to passenger vehicles, sports cars, sport utility vehicles (SUVs), buses, trucks, tractors, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the attached drawings.

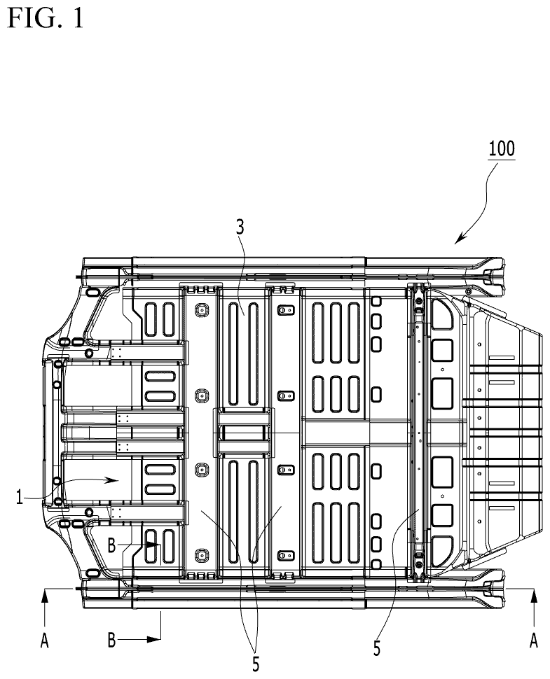

FIG. 1 is a top plan view illustrating a side sill structure for an electric vehicle according to an embodiment of the present disclosure.

Referring to FIG. 1, a side sill structure for an electric vehicle 100 according to an embodiment of the present disclosure may be applied to a vehicle body of an electric vehicle.

In this specification, the reference direction for describing the components below may be set as the front-rear direction of the vehicle 100 (e.g., the length direction or longitudinal direction of the vehicle), the vehicle width direction of the vehicle 100 (e.g., the transverse direction), and the vehicle vertical direction (e.g., the height direction or up down direction).

In this specification, “upper end,” “upper portion,” or “upper surface” of a component indicates an end, portion, or surface of a component that is relatively upper as illustrated in the drawing, and “lower end,” “lower portion,” or “lower surface” of a component indicates an end, portion, or surface of a component that is relatively lower as illustrated in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

A side sill structure for an electric vehicle 100 according to an embodiment of the present disclosure can be connected to each side of a floor structure 1 in the vehicle body of the electric vehicle along the vehicle width direction, and can be arranged along the front-rear direction of the vehicle body.

The floor structure 1 can include a floor panel 3 (e.g., a center floor panel) and a plurality of cross members 5 joined along the vehicle width direction to the upper surface of the floor panel 3.

Both sides of the floor panel 3 along the vehicle width direction and both sides of the cross members 5 along the vehicle width direction may be connected with the side sill structure for an electric vehicle 100 according to an embodiment of the present disclosure.

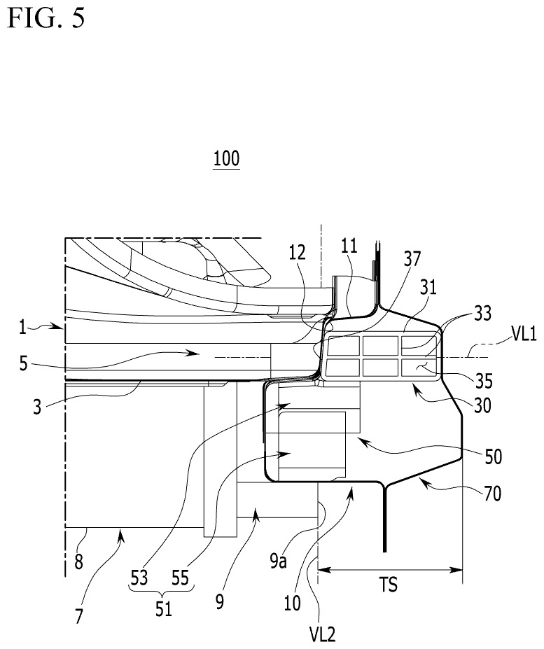

A battery assembly 7 (see FIG. 5) can be mounted on the lower portion of the floor structure 1. Both sides of the battery assembly 7 along the vehicle width direction may be connected to the side sill structure for an electric vehicle 100 according to an embodiment of the present disclosure.

The side sill structure for an electric vehicle 100 according to an embodiment of the present disclosure may minimize side sill rotation due to side collision of the electric vehicle and provide a structure that may reduce collision energy transferred to the battery assembly 7.

The side sill structure for an electric vehicle 100 according to an embodiment of the present disclosure may provide a structure that may reduce the size of a vehicle body mount part of the battery assembly 7 and reduce the number of parts of battery mount parts of the battery assembly 7.

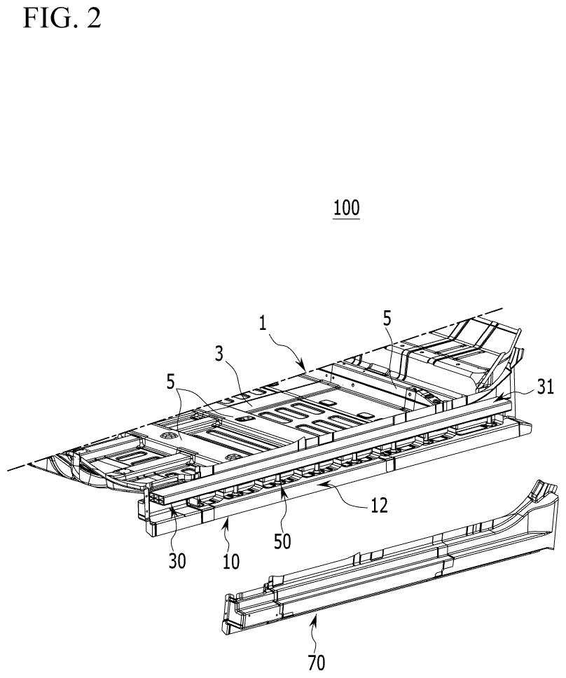

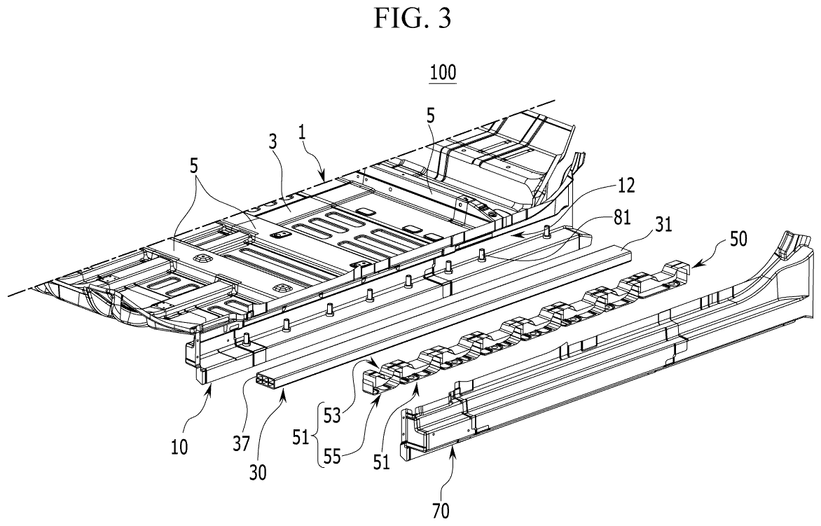

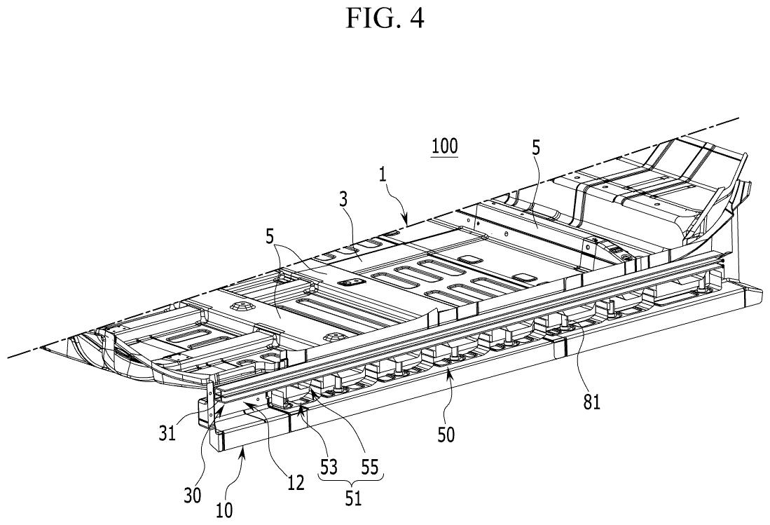

FIG. 2 is a partial exploded perspective view illustrating a side sill structure for an electric vehicle according to an embodiment of the present disclosure. FIG. 3 is an exploded perspective view illustrating a side sill structure for an electric vehicle according to an embodiment of the present disclosure. FIG. 4 is a perspective view illustrating a side sill structure for an electric vehicle according to an embodiment of the present disclosure. FIG. 5 is a cross-sectional view along line B-B of FIG. 1.

Referring to FIG. 1 to FIG. 5, the side sill structure for an electric vehicle 100 according to an embodiment of the present disclosure can include a sill inner member 10, an upper reinforcing member 30, a lower reinforcing member 50, and a sill outer member 70.

In an embodiment of the present disclosure, the sill inner member 10 can include a panel piece of steel material formed into a set, selected, or predetermined shape (e.g., stepped shape).

The sill inner member 10 can be connected to each side of the floor structure 1 along the vehicle width direction and can be arranged along the front-rear direction of the vehicle body. The sill inner member 10 can include an inner surface 11 and an outer surface 12.

The inner surface 11 of the sill inner member 10 can be connected to both sides of the floor panel 3 and cross members 5 provided in the floor structure 1 along the vehicle width direction.

In an embodiment of the present disclosure, the upper reinforcing member 30 can be configured to reinforce the side strength of the vehicle body.

The upper reinforcing member 30 can be connected to the outer surface 12 at the upper portion of the sill inner member 10 and can be arranged along the front-rear direction of the vehicle body.

The upper reinforcing member 30 can include, in one example, an aluminum extrusion member 31 having a generally rectangular cross-section shape. The aluminum extrusion member 31 may, in another example, include a plurality of closed sections 35 partitioned by at least one barrier rib 33.

The upper reinforcing member 30 may be connected to the sill inner member 10 by a mechanical junction method using a SPR (Self Piercing Rivet) or FDS (Flow Drill Screw). The cross members 5 and upper reinforcing member 30 of the floor structure 1 may be placed on a first imaginary line VL1 along the vehicle width direction.

As described above, the battery assembly 7 can be mounted on the lower part of the floor structure 1. The battery assembly 7 can include side frames 9 connected to each side of a battery pack 8. The side frame 9 may be connected to the lower part of the sill inner member 10 through an engage unit of a combination of bolts and nuts. The side frame 9 may, in one example, include an aluminum extrusion.

A side surface 37 of the upper reinforcing member 30 connected to the outer surface 12 of the sill inner member 10 and a side surface 9a of the side frame 9 may be arranged on a second imaginary line VL2 along the vertical direction.

The ends of cross members 5 can be connected to the inner surface 11 of the sill inner member 10 at positions corresponding to the side surface 37 of the upper reinforcing member 30 and the side surface 9a of the side frame 9 may be placed on the second imaginary line VL2.

In an embodiment of the present disclosure, the lower reinforcing member 50 can be configured to reinforce the side strength of the vehicle body and connect the cross members 5, the upper reinforcing member 30, and the side frame 9 of the battery assembly 7 along the vertical direction.

The lower reinforcing member 50 can be positioned along the front-rear direction of the vehicle body on the lower side of the upper reinforcing member 30 and can be connected to the lower portion of the upper reinforcing member 30 and the outer surface (12, e.g., the step surface) of the sill inner member 10.

The lower reinforcing member 50 can include a plurality of cell assemblies 51 sequentially connected along the front-rear direction the vehicle body. The lower reinforcing member 50 according to an embodiment of the present disclosure may be provided in a honeycomb shape in which a plurality of cells can be continuously formed along the front-rear direction of the vehicle body by cell assemblies 51.

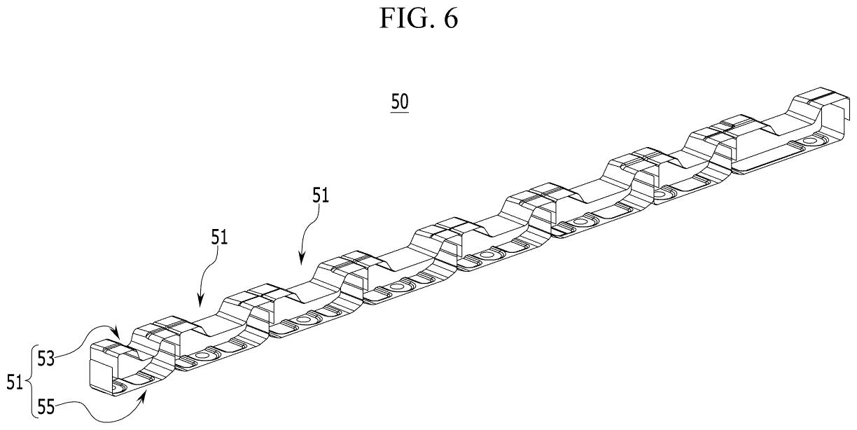

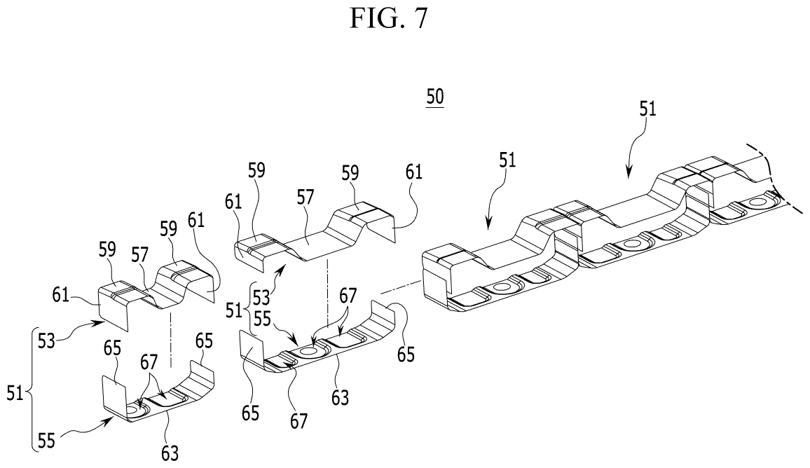

FIG. 6 is a combined perspective view illustrating a lower reinforcing member applied to a side sill structure for an electric vehicle according to an embodiment of the present disclosure. FIG. 7 is an exploded perspective view illustrating a cell assembly of a lower reinforcing member applied to a side sill structure for an electric vehicle according to an embodiment of the present disclosure.

Referring to FIG. 2 to FIG. 7, each of the cell assemblies 51 of the lower reinforcing member 50 according to an embodiment of the present disclosure can include an upper cell body 53 of steel material and a lower cell body 55 of steel material.

The upper cell body 53 can be press formed into a set, selected, or predetermined shape and connected to the lower surface of the upper reinforcing member 30. In one example, the upper cell body 53 may be provided with a “M” shaped cross-section.

The upper cell body 53 can include an upper forming part 57, an upper connecting part 59, and upper rib portions 61.

The upper forming part 57 can be formed concavely downward from the upper center of the upper cell body 53. The upper connecting part 59 can extend forward and backward from the upper ends on both sides of the upper forming part 57, respectively.

The upper connecting part 59 may be connected to the lower surface of the upper reinforcing member 30 by a mechanical junction method using SPR or FDS.

The upper rib portions 61 each can extend downwardly from the upper connecting part 59. The upper connecting part 59 can be connected along the front-rear direction of the vehicle body to the lower cell body 55, which will be described later.

The lower cell body 55 can be press-formed into a set, selected, or predetermined shape and placed below the upper cell body 53.

The lower cell body 55 can be connected to the lower portion of the upper cell body 53 and to the outer surface 12 of the sill inner member 10. In one example, the lower cell body 55 may be provided with a “U” shaped cross-section.

The lower cell body 55 can be connected to the upper cell body 53 and may form a honeycomb cell.

The lower cell body 55 can include a lower connecting part 63 and lower rib portions 65.

The lower connecting part 63 can be formed along the front-rear direction of the vehicle body of the lower cell body 55 and can be connected to the outer surface 12 of the sill inner member 10.

The lower connecting part 63 may be connected to the outer surface 12 of the sill inner member 10 by a mechanical junction method using SPR or FDS.

The lower connecting part 63 can include at least one lower forming part 67 that is concave downward. The at least one lower forming part 67 may be connected to the outer surface 12 of the sill inner member 10 by a mechanical junction.

The lower rib portions 65 can extend upwardly from both sides of the lower connecting part 63 and can be connected to the upper rib portions 61 of the upper cell body 53 along the front-rear direction of the vehicle body.

Based on the unit cell of the cell assemblies 51, the upper rib portions 61 of the upper cell body 53 and the lower rib portions 65 of the lower cell body 55 may be connected by welding.

The upper rib portions 61 and the lower rib portions 65 of the upper cell body 53 and the lower cell body 55 of the cell assemblies 51, which can be adjacent to each other along the front-rear direction of the vehicle body, may be connected by welding.

Referring to FIG. 2 to FIG. 5, in an embodiment of the present disclosure, the sill outer member 70 can include a panel component of steel material formed into a set, selected, or predetermined shape (e.g., stepped shape).

The upper reinforcing member 30 and the lower reinforcing member 50 can be arranged between the sill outer member 70 and the sill inner member 10 (e.g., sandwiched between and/or enclosed within). The sill outer member 70 can be arranged along the front-rear direction of the vehicle body and can be connected to the outer surface 12 of the sill inner member 10. The sill outer member 70 may be connected to the sill inner member 10 by welding.

The sill outer member 70 can be connected to the upper reinforcing member 30. The sill outer member 70 may be connected to the upper reinforcing member 30 by a mechanical junction using SPR or FDS.

A section from the side surface 37 of the upper reinforcing member 30 to the side surface 9a of the side frame 9 of the battery assembly 7 to the sill outer member 70 may be defined as a transformation section TS.

Referring to FIG. 3 and FIG. 4, the sill inner member 10 can be connected with weld nuts 81. The weld nuts 81 can be spaced apart at set, selected, or predetermined intervals along the front-rear direction of the vehicle body.

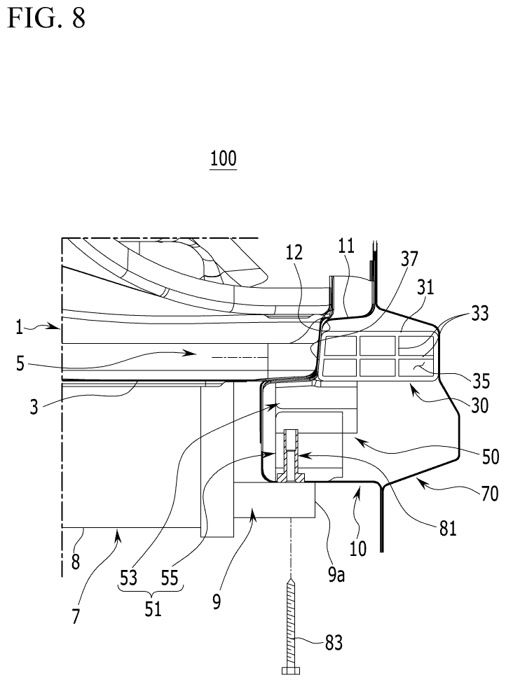

FIG. 8 is a cross-sectional view illustrating a battery assembly mounting structure of a side sill structure for an electric vehicle according to an embodiment of the present disclosure.

The weld nuts 81, as shown in FIG. 8, can penetrate the sill inner member 10 and the lower cell body 55 in the vertical direction and can be connected to the sill inner member 10 by welding.

The side frame 9 of the battery assembly 7, which can be mounted on the lower part of the floor structure 1, may be connected to the lower part of the sill inner member 10 by engaging bolts 83, which can be engaged with weld nuts 81.

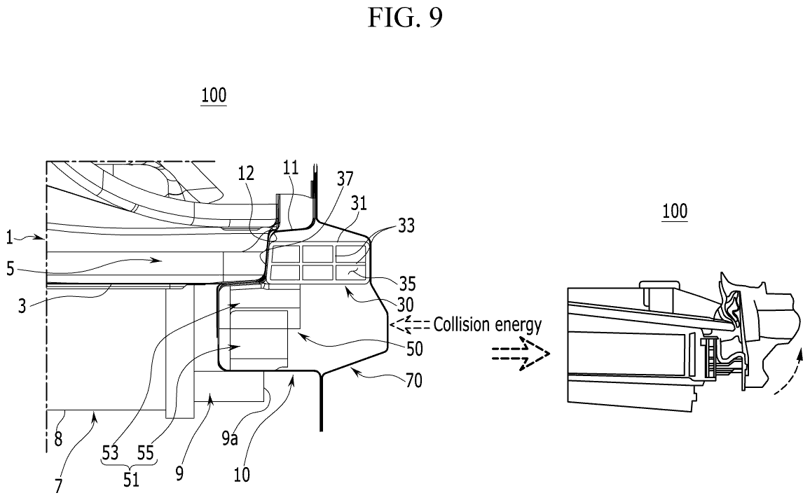

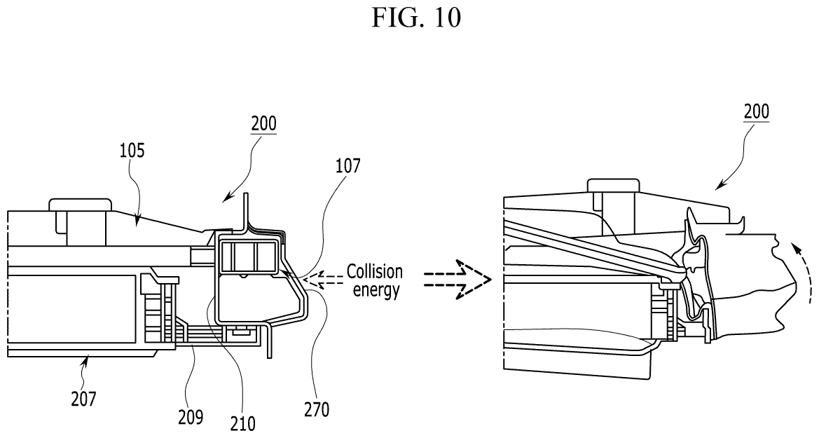

FIG. 9 is a drawing for explaining the operation of a side sill structure for an electric vehicle according to an embodiment of the present disclosure. FIG. 10 is a drawing illustrating an example for comparison with a side sill structure for an electric vehicle according to an embodiment of the present disclosure.

Hereinafter, the operation of the side sill structure for an electric vehicle 100 according to an embodiment of the present disclosure configured as described above will be described in detail with reference to FIG. 1 to FIG. 10.

In an embodiment of the present disclosure, the sill inner member 10 and the sill outer member 70 can be provided as being connected to each other.

The sill inner member 10 and the sill outer member 70, which can be connected to each other, can be arranged along the front-rear direction of the vehicle body. The sill inner member 10 can be connected to both sides of the floor panel 3 and cross members 5 provided in the floor structure 1 along the vehicle width direction.

On the inner side of the sill inner member 10 and the sill outer member 70, the upper reinforcing member 30 can be mounted along the front-rear direction of the vehicle body. The upper reinforcing member 30 can include the aluminum extrusion member 31.

The lower reinforcing member 50 can be mounted on the inner side of the sill inner member 10 and the sill outer member 70. The lower reinforcing member 50 can include the honeycomb shaped cell assemblies 51 that can be welded connected sequentially along the front-rear direction of the vehicle body.

The aluminum extrusion member 31 can be connected to the sill inner member 10 and the sill outer member 70 by a mechanical junction method using SPR or FDS. The cell assemblies 51 can be placed on the lower side of the aluminum extrusion member 31 and can be connected to the aluminum extrusion member 31 by a mechanical junction method using SPR or FDS, and can be connected to the sill inner member 10 by welding.

In an embodiment of the present disclosure, the side frame 9 of the battery assembly 7 can be connected along a vertical direction to the lower portion of the sill inner member 10. The side frame 9 may be connected to the lower portion of the sill inner member 10 by the weld nuts 81 connected to the sill inner member 10 and the engaging bolts 83 engaged by the weld nuts 81.

The cell assemblies 51 can connect the cross members 5 of the floor structure 1, the aluminum extrusion member 31, and the side frames 9 of battery assembly 7 along the vertical direction.

In an embodiment of the present disclosure, the cross members 5 and the aluminum extrusion member 31 can be arranged on the first imaginary line VL1 along the vehicle width direction.

In an embodiment of the present disclosure, the side surface 37 of the aluminum extrusion member 31 can be connected to the sill inner member 10 and the side surface 9a of the side frame 9 and arranged on the second imaginary line VL2 along the vertical direction.

The ends of the cross members 5 can be connected to the sill inner member 10 and the side surface 9a of the side frame 9 and placed on the second imaginary line VL2.

For a side sill structure for an electric vehicle 100 according to an embodiment of the present disclosure, when a side surface collision occurs, collision energy can be absorbed through the aluminum extrusion member 31 in the transformation section TS. The aluminum extrusion member 31, the cross members 5 positioned on the first imaginary line VL1, and the side frame 9 of the battery assembly 7 can form a load path in the vertical direction.

A side sill structure for an electric vehicle 100 according to an embodiment of the present disclosure may minimize side sill rotation due to a side collision, as shown in FIG. 9, because the ends of cross members 5, the side surfaces 37 of the aluminum extrusion members 31, and the side surfaces 9a of the side frames 9 are arranged on second imaginary line VL2.

For a side sill structure for an electric vehicle 100 according to an embodiment of the present disclosure, because the cell assemblies 51 can connect the cross members 5, the aluminum extrusion member 31, and the side frame 9 of the battery assembly 7 along the vertical direction, side sill distortion due to the side collision may be suppressed.

The overlap ratio of the aluminum extrusion member 31 and the cell assemblies 51 may satisfy, for example, 30%. This can prevent the cell assemblies 51 from being lifted together with the aluminum extrusion member 31 in the event of a side collision, thereby preventing rotation of the cell assemblies 51.

For a side sill structure for an electric vehicle 100 according to an embodiment of the present disclosure, damage to the battery assembly 7 may be prevented by reducing collision energy transmitted to the battery assembly 7 when a side collision occurs. According to a side sill structure for an electric vehicle 200 according to a comparative example as illustrated in FIG. 10, an aluminum extrusion 107 can be mounted between a sill inner member 210 and a sill outer member 270 that are connected to each other.

For a side sill structure for an electric vehicle 200 according to the comparative example of FIG. 10, an end of a cross member 105 and an end of a side frame 209 of a battery assembly 207 are not arranged on the same line along the vertical direction.

In the side sill structure for an electric vehicle 200 according to the comparative example of FIG. 10, the side frame 209 is a structure that extends long toward the sill outer member 270 with the end of the cross member 105 as a reference along the vehicle width direction.

Therefore, according to the side sill structure for an electric vehicle 200 according to the comparative example of FIG. 10, when a side collision occurs, collision energy may be intensively transferred to the side frame 209 of the battery assembly 207 from the beginning of the collision.

Because the side frame 209 of the battery assembly 207 may act as a hinge, the torque of the side sill due to collision energy may increase.

Accordingly, according to the side sill structure for an electric vehicle 200 according to the comparative example of FIG. 10, when a side collision occurs, collision energy is concentrated on the upper portion of the battery assembly 207, which may cause deformation and damage to the battery assembly 207.

However, unlike the comparative example, a side sill structure for an electric vehicle 100 according to an embodiment of the present disclosure may reduce the length of the side frame 9 of the battery assembly 7 along the vehicle width direction by applying the upper reinforcing member 30 and the lower reinforcing member 50.

A side sill structure for an electric vehicle 100 according to an embodiment of the present disclosure may minimize side sill rotation due to collision energy when a side collision occurs, and safely protect the battery assembly 7.

A side sill structure for an electric vehicle 100 according to an embodiment of the present disclosure may secure side collision performance of an electric vehicle, prevent deformation and damage of the battery assembly 7 due to collision energy, and secure collision safety of an occupant.

A side sill structure for an electric vehicle 100 according to an embodiment of the present disclosure may reduce the overlapping mechanical strength parts between the vehicle body and the battery assembly 7 and the battery mount parts of the battery assembly 7, thereby improving the battery integration and volume ratio of the battery assembly 7.

While the present disclosure has been described in connection with what is presently considered to be practical example embodiments, it can be understood that the present disclosure is not necessarily limited to the disclosed example embodiments. On the contrary, the present disclosure is intended to cover various modifications and equivalent arrangements included within the spirit and scopes of the appended claims.

What is claimed is:

1. A side sill structure for a vehicle comprising:
a sill inner member configured to be connected to each side of a floor structure at a vehicle width direction and arranged along a front-rear direction of a vehicle body;
an upper reinforcing member connected to an outer surface of the sill inner member and arranged along the front-rear direction of the vehicle body;
a lower reinforcing member connected to a lower surface of the upper reinforcing member and the outer surface of the sill inner member, and arranged along the front-rear direction of the vehicle body; and
a sill outer member connected to the outer surface of the sill inner member and the upper reinforcing member and positioned along the front-rear direction of the vehicle body.

2. The side sill structure of claim 1, wherein floor panels and cross members of the floor structure are connected on both sides of the vehicle width direction to an inner surface of the sill inner member; and
wherein the cross members and the upper reinforcing member are positioned on a first imaginary line along the vehicle width direction.

3. The side sill structure of claim 2, wherein the sill inner member is connected to a side frame on a battery-assembly side of a battery assembly mounted on a lower part of the floor structure; and
wherein an upper-reinforcing-member side surface of the upper reinforcing member connected to the outer surface of the sill inner member and a side-frame side surface of the side frame are arranged on a second imaginary line along a vertical direction.

4. The side sill structure of claim 3, wherein a section from the upper-reinforcing-member side surface of the upper reinforcing member and the side-frame side surface of the side frame to the sill outer member is a transformation section.

5. The side sill structure of claim 1, wherein the upper reinforcing member comprises an aluminum extrusion member; and
wherein the aluminum extrusion member comprises a plurality of closed sections separated by at least one barrier rib.

6. The side sill structure of claim 1, wherein the lower reinforcing member comprises a plurality of cell assemblies connected sequentially along the front-rear direction of the vehicle body.

7. The side sill structure of claim 6, wherein the lower reinforcing member has a honeycomb shape along the front-rear direction of the vehicle body by the cell assemblies.

8. The side sill structure of claim 6, wherein each of the cell assemblies comprises:
an upper cell body of steel material connected to a lower face of the upper reinforcing member; and
a lower cell body of steel material connected to a lower part of the upper cell body and connected to the outer surface of the sill inner member.

9. The side sill structure of claim 8, wherein the upper cell body has an M-shaped cross-section.

10. The side sill structure of claim 9, wherein the lower cell body has a U-shaped cross-section.

11. The side sill structure of claim 8, wherein the upper cell body comprises:
an upper forming part that is concave from a top to a bottom of the upper forming part;
an upper connecting part that extends forward and backward from the upper forming part and is connected to the lower surface of the upper reinforcing member; and
upper rib portions each extending downward from the upper connecting part.

12. The side sill structure of claim 11, wherein the lower cell body comprises:
a lower connecting part along the front-rear direction of the vehicle body and connected to the outer surface of the sill inner member; and
lower rib portions extending upward from each side of the lower connecting part.

13. The side sill structure of claim 12, wherein the upper rib portions and the lower rib portions of each of the cell assemblies are connected by welding.

14. The side sill structure of claim 13, wherein the upper rib portions and the lower rib portions of the cell assemblies, which are adjacent to each other along the front-rear direction of the vehicle body, are connected by welding.

15. The side sill structure of claim 8, wherein weld nuts that penetrate the sill inner member and the lower cell body in a vertical direction are connected to the sill inner member.

16. A side sill structure for a vehicle comprising:
a sill inner member configured to be connected to each side of a floor structure at a vehicle width direction and arranged along a front-rear direction of a vehicle body;
an upper reinforcing member connected to an outer surface of the sill inner member and arranged along the front-rear direction of the vehicle body;
a lower reinforcing member connected to a lower surface of the upper reinforcing member and the outer surface of the sill inner member, and arranged along the front-rear direction of the vehicle body, wherein the lower reinforcing member comprises a plurality of cell assemblies connected sequentially along the front-rear direction of the vehicle body; and
a sill outer member connected to the outer surface of the sill inner member and the upper reinforcing member and positioned along the front-rear direction of the vehicle body.

17. The side sill structure of claim 16, wherein each of the cell assemblies comprises:
an upper cell body connected to a lower face of the upper reinforcing member, wherein the upper cell body has an M-shaped cross-section; and
a lower cell body connected to a lower part of the upper cell body and connected to the outer surface of the sill inner member, wherein the lower cell body has a U-shaped cross-section.

18. A vehicle comprising:
a floor structure; and
a side sill structure comprising:
a sill inner member connected to each side of the floor structure at a vehicle width direction and arranged along a front-rear direction of a vehicle body,
an upper reinforcing member connected to an outer surface of the sill inner member and arranged along the front-rear direction of the vehicle body,
a lower reinforcing member connected to a lower surface of the upper reinforcing member and the outer surface of the sill inner member, and arranged along the front-rear direction of the vehicle body, and
a sill outer member connected to the outer surface of the sill inner member and the upper reinforcing member and positioned along the front-rear direction of the vehicle body.

19. The vehicle of claim 18, wherein the floor structure comprises floor panels and cross members, wherein of the floor panels and the cross members are connected on both sides of the vehicle width direction to an inner surface of the sill inner member; and
wherein the cross members and the upper reinforcing member are positioned on a first imaginary line along the vehicle width direction.

20. The vehicle of claim 19, further comprising a battery assembly mounted on a lower part of the floor structure, wherein the battery assembly includes a side frame on a battery-assembly side of the battery assembly, and wherein the sill inner member is connected to the side frame; and
wherein an upper-reinforcing-member side surface of the upper reinforcing member connected to the outer surface of the sill inner member and a side-frame side surface of the side frame are arranged on a second imaginary line along a vertical direction.
